(19) United States
(12) Patent Application Publication
(10) Pub. No.: US 2016/0092095 A1
(43) Pub. Date: Mar. 31, 2016

(54) USER INTERFACE FOR CONTROLLING SOFTWARE APPLICATIONS

(71) Applicant: FAIRLIGHT.AU PTY LTD, Frenchs Forest, New South Wales (AU)

(72) Inventor: Tino FIBAEK, Frenchs Forest, New South Wales (AU)

(21) Appl. No.: 14/892,352

(22) PCT Filed: May 21, 2014
(86) PCT No.: PCT/AU2014/050047

§ 371 Date: Nov. 19, 2015

(30) Foreign Application Priority Data
May 21, 2013 (AU) 2013901815

(51) Int. Cl. G06F 3/0484; G06F 3/0488; G06F 3/0486

(52) U.S. Cl. CPC G06F 3/04847; G06F 3/0486; G06F 3/04886

(57) ABSTRACT

An apparatus configured as a user interface for controlling software applications, the apparatus comprising: a display screen; an array of tactile control elements; a masking element configured to conceal at least part of the display screen and reveal at least one display area, wherein at least one display area is for displaying a current function of at least one tactile control element; and a translator responsive to a user originated event to carry out a function of one or more software applications assigned to the user originated event, wherein a user originated event includes the actuation of a tactile control dement to carry out the current function of the tactile control element displayed on the display area, wherein a graphic user interface application is configured to enable a user to assign functions of one or more software applications to user originated events and arrange a pre-determined layout of functions assigned to one or more tactile control elements of the apparatus.

### FIELD OF THE INVENTION

The invention relates to a user interface for controlling software applications. The invention has many potential. applications and is particularly suitable to the field of media production, including audio, video, film and multi-media production. It is specifically applicable to such production tasks as editing, mixing, effects processing, format conversion and pipelining of the data used in to digital manipulation of the content for these media, although it is not limited to these applications.

### BACKGROUND OF THE INVENTION

Computers today offer fast colour graphics and weIl-designed graphical user interfaces, primarily driven by mouse, keyboard and other peripherals. However, mouse interfaces, though quick to learn, are ultimately limited in speed by the amount of hand-eye movement required for specific commands, They may he quite suitable for occasional or casual use, but for professional use they are easily outstripped by dedicated hardware surfaces where users' hands learn sequences of actions, leaving the conscious mind free to concentrate on the content of the current task. True “look-away” operation may only be achieved by putting functions within reach of the user's hands. For example, musicians typically play better when they don't look at the keyboard fret-hoard.

Touch screens have the ability to change function and appearance according to context. which has been an extremely successful paradigm, especially in smartphones and point of sale applications. However, touch screens alone may he unsuitable for complex and high-throughput situations. In, for example, complex audio-visual production environments, interfaces that incorporate physical “feel” may enhance working speed as operators need to concentrate on video footage, voice an talent, or other control elements such as levers, faders and knobs. Touch screens lack tactile response, so there is no physical feedback.

While buttons in fixed-key controllers provide immediate tactile feedback, where a large number of functions are required the footprint of the resulting controller may he unworkable. A set of keyboard shortcuts and/or modifiers (which temporarily change sonic key functions) may be incorporated into a fixed-key controller to add more functions to a smaller footprint, but typically operators learn only a small sub-set of shortcuts, because their available learning time is limited.

Accordingly. with increasing functionality, particularly in complex and high-throughput situations, there is a continued need to provide improved user interfaces for controlling software applications.

It is an object of the invention to substantially overcome or at least ameliorate one or more of the disadvantages of the prior art.

### SUMMARY OF THE INVENTION

In an aspect, the invention provides an apparatus configured as a user interface for controlling software applications, the apparatus comprising:
a display screen;
an array of tactile control elements;
a masking element configured to conceal at least part of the display screen and reveal at least one display area, wherein at least one display area is for displaying a current function of at least one tactile control element; and
a translator responsive to a user originated event to carry out a function of one or more software applications assigned to the user originated event, wherein a user originated event includes the actuation of a tactile control element to carry out the current function of the tactile control element displayed on the display area,
wherein a graphic user interface application is configured to enable a user to assign functions of one or more software applications to user originated events and arrange a pre-determined layout of functions assigned to one or more tactile control elements of the apparatus.

In another aspect, the invention provides an apparatus configured as a user an interface, the apparatus comprising:
a display screen;
an array of tactile control elements;
at least one layout control element;
a masking element configured to conceal at least part of the display screen and reveal at least one display area wherein at least one display area is for displaying a current function of at least one tactile control element;
a translator responsive to a user originated event to carry out a function of one or more software applications assigned to the user originated event, wherein a user originated event includes the actuation of a tactile control element to carry out the current function of the tactile control element displayed on the display area; and
a translator responsive to a user actuating a layout control element and in configured to cause displaying of information on at least one display area including displaying information corresponding to the current function of one or more tactile control elements,
wherein a graphic user interface application is configured to enable a user to assign functions of one or more software applications to user originated events and arrange a pre-determined layout of functions assigned to one or more tactile control elements of the apparatus, and actuation of the layout control clement changes between pre-determined layouts of functions assigned to one or more tactile control elements.

In yet another aspect, the invention provides a user interface system for controlling software applications, the system comprising:
a graphic user interface application configured to enable a user to assign functions of one or more Software applications to user originated events; and
a translator responsive to a user originated event to carry out a function of one OT more software applications assigned to the user originated event,
wherein the user originated events include one or more of: actuation of a tactile control element, a speech command, a two-dimensional gesture, a three dimensional gesture.

In a further aspect, the invention provides a user interface system for controlling software applications, the system comprising:
an a display screen;
at least one layout control element;
a graphic user interface application configured to enable a user to assign functions of one or more software applications to user originated events;
a translator responsive to a user originated event to carry out a function of one or more software applications assigned to the user originated event; and
a translator responsive to a user actuating a layout control element and configured to cause displaying of information on the display screen including displaying information corresponding to the current function of one or more user originated events,
wherein the user originated events include one or more of: actuation of a in tactile control element, a speech command, a two-dimensional gesture, a three dimensional gesture, and actuation of the layout control element changes between pre determined layouts of functions assigned to user originated events.

In arrangements of any of the following aspects, a tactile control element may be a switch comprising a translucent cap. A display area may be viewable through the translucent cap for displaying a current function of the switch. An image conduit may be disposed between the display and the translucent cap. The image conduit may comprise a plurality of parallel optic fibres in fixed contact at a first end to the display area.

A tactile control clement may be a knob. The knob may be configured to manipulate the information displayed on a display area Preferably the masking element includes a protective product surface.

The graphic user interface application may be configured to allow drag-and-drop editing of the functions of one or more software applications assigned to user originated events, including a layout of functions assigned to one or more tactile control elements of an apparatus.

### BRIEF DESCRIPTION OF THE DRAWINGS

Preferred embodiments of the invention will now be described with reference to the accompanying drawings wherein:

FIG. 1 is of a high-level operation of a user interface in accordance with embodiments of the invention;

FIG. 2 is a simplified flow diagram illustrating the concept behind multiple layouts of functions in accordance with embodiments of the invention;

FIGS. 3a through 3c depict examples of hardware control surfaces suitable for use with embodiments of the invention;

FIG. 4 is a screenshot of a graphic user interface application configured to enable a user to arrange a pre-determined layout of functions assigned to one or more tactile control elements of an apparatus in accordance with embodiments of the invention;

FIG. 5 is an example translator suitable for use with embodiments of the invention;

FIG. 6 is a schematic view of an image conduit comprising a plurality of parallel optic fibres in fixed contact at a first end to a display area;

FIG. 7 is a simplified schematic of a switch mechanism comprising a translucent cap; and,

FIG. 8 is a section view of a controller, showing three layouts on the lower keys in Editor Mode, English keyboard and Japanese keyboard.

### DESCRIPTION OF THE PREFERRED EMBODIMENTS

Embodiments of the invention may enable control of software applications running on PC, Mac or Linux operating systems, and communication via built-in protocols and command sets, including RS-422, MIDI, ASCII, Ethernet, HUI and more. It is a solution that may he application-aware, and therefore able to switch focus nearly instantly between different software applications, or launch them if not currently active. It may also be language aware, allowing it to choose appropriate graphical symbols and layouts for working in the current language of the hardware running the software application.

In preferred embodiments, the powerful combination of software scripting with hardware interfaces may enable complex interactions with software applications, and accurate tallying of resultant changes back to the hardware displays.

Referring to FIG. 1, there is depicted a high-level operation of a user interface in accordance with embodiments of the invention;

1: Event (User Originated)

A tactile operation by a user, for example, knob turned, switch actuated, fader moved.

A speech command by a user into a microphone, for example, when mixing multi-track audio, the user may issue verbal commands such as:
“Play” (plays from current position)
“Play Again” (plays again from last starting point)
“Stop”
“Play All” (plays the track from the start)
“Call Vocal” (brings the channel with the vocal into focus)

A two-dimensional gesture. for example, a three-finger swipe of a touch screen from right to left to delete.

A three-dimensional gesture, for example:
Reach out and grab (make fist, engages the three-dimensional gesture control)
Move hand in three-dimensions to manipulate virtual object.
Twist, tilt, yaw hand for advanced manipulation.
Reach out and release (open fist, disengages the three-dimensional gesture control).

2: Event Analysis

Building on the previous examples, switch on or off, knob rotation speed and/or amount, fader touch.

A dictionary engine to analyse speech commands. See, for example, Microsoft Speech API (SAPI) 5.4 (http://msdninicrosoft.corn/en-us/library/ce125663(v=vs.85).aspx last accessed 21 May 2014) or the Dragon NaturallySpeaking software developer kit (SDK) (http://www.nuance.com/for-developers/dragon/index.htm last accessed 21 May 2014).

A gesture engine analyses the two-dimensional and/or three-dimensional gestures. See, for example, the Skeletal SDK (https://developer.leaptnotion.com/ last accessed 21 May 2014).

3: Translator

Applies logic to determine a sequence of actions based on event parameters and depending on prevailing conditions in the application. The logic is applied via algorithms implemented via scripting language or similar means.

4: Actions

Actions are communicated to the software application via an Application Programming Interface (API) that is linked into the scripting language.

5: Information

Software application communicates parameter changes to Translator via API.

6: Translator

Applies logic to determine how information will he displayed on the physical interface. The logic is applied via algorithms implemented via scripting language or similar means.

7: Tally

For example, light turns on fader moves, screen updates, switch label changes, Text-to-Speech (TTS) audibly communicates feedback via speaker,

High-level interactions as shown above require communication of product database information in both push and pull modes. In some cases one or both modes are not supported, and the invention solution has options to do the most possible with any setup.

If, for example, information is not pushed hack from the application, a database of the application parameter set may be maintained independent of the application and updated based on a known starting position and the changes it has generated. This can work well if the user interface in accordance with the invention is the sole controller of the application. In this case, steps 1 through 3 and 6 through 7 of the above example would be executed.

The invention may be operable at even lower levels, where the application interface is not highly-developed.

For example, a product may use a set of keyboard shortcuts to increase working speed. Typically operators learn a small sub-set of the shortcuts, because their available learning time is limited. Tallying in this instance will be absent though, because the keyboard shortcut interface is nm-directional. In this case, only steps 1 through 3 of the above example would be executed.

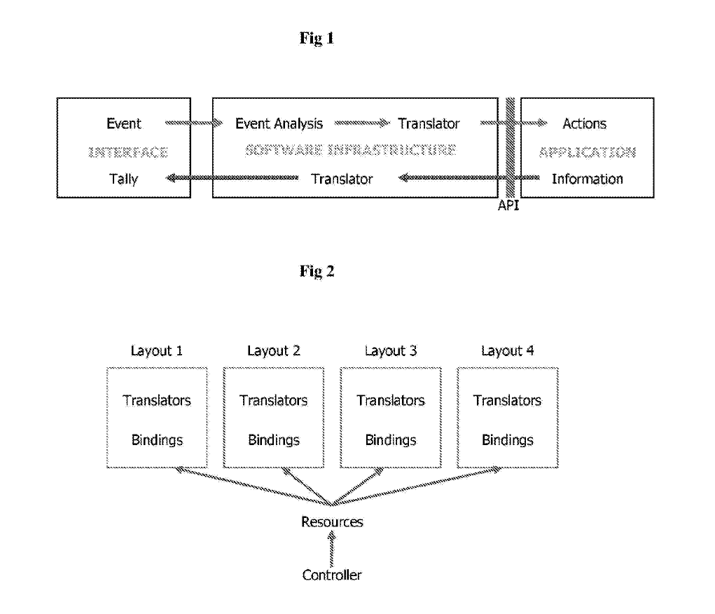

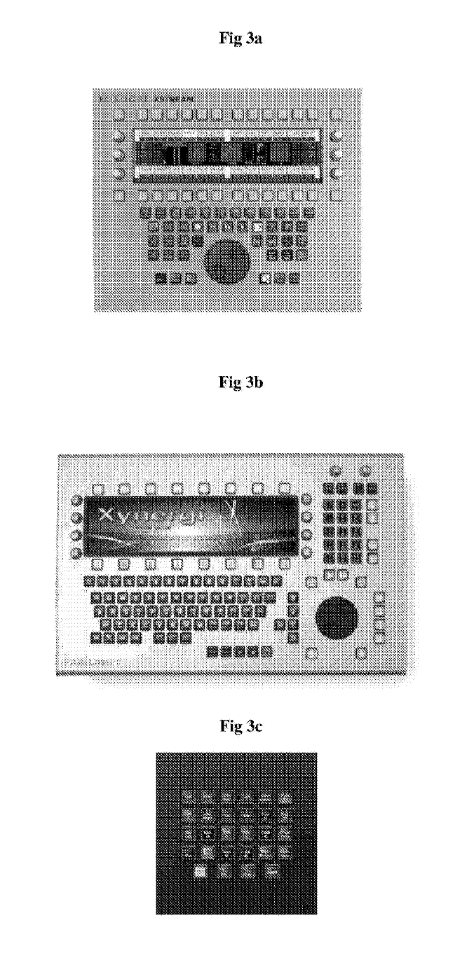

Referring to FIG. 2 there is depicted a simplified flow diagram illustrating the concept behind multiple layouts of functions in accordance with embodiments of the invention. In embodiments of the invention an apparatus configured as a user interface starts with a hardware control surface (included within the meaning of the term Controller used in FIG. 2). FIGS. 3a through 3c depict examples of hardware control surfaces suitable for use with embodiments of the invention.

A hardware control surface (or Controller) may comprise a collection of to Resources, including tactile control elements. Example types of such Resources include:
Picture Key (see below).
Led Key.
Touch sensitive Encoder.
Jogger.
Meter.
EQ curve.
Knob.

A Controller may be any other suitable piece of hardware comprising Resources to receive user originated events. For example, a Controller may include a touch screen to receive two-dimensional gestures and/or a microphone to receive speech commands.

Bindings are created between these Resources and functions are defined through a scripting language, and are referred to as Translators.

A Binding is the association of a user originated event (received by a

Resource) with a Translator. Additionally, the binding may contain meta-data in the form of numeric and text constants. For example, the binding to create the ‘Q’ function of the QWERTY could contain the following:
Binding to a generic Keyboard translator.
Name of the bitmap to display in the key: “q.BMP”.
The ASCII (American Standard Code for Information Interchange) code to send to the system: 122.

A Translator translates between a user originated event (for example, actuation of a switch or a speech command) and an application (for example, GVG's Edius®, Apple's Final Cut Pro® or Avid's MediaComposer®). It may be a piece of ‘C’ code that complies with certain rules. It may be compiled at runtime by the Tiny C compiler, and thus facilitate very fast turnaround of ideas and concepts into real-world tests and trials, “Tiny C” is just one example of scripting mechanism ‘C’, exemplified through a specific compiler “Tiny C”. This could equally well be, for example, a language such as Basic, executed via Microsoft's Visual Basic for Applications (VBA).

Each translator implements two primary functions:
An event handler that is called in response to various forms of stimuli (user originated events).
An update function that is called from within the translator and whenever the assigned function is available.
An example Translator is a HUI-based PLAY key with MMC-based feedback:
It's event handler transmits HUI MIDI messages to a target application corresponding to key down/up events.
It's update function receives MMC MIDI data from the application, and updates the image on the key whenever the transport mode goes in or out of PLAY.

A translator is implicitly called in response to a user originated event it is bound to. Additionally, the translator can specify additional triggers, such as, for example, one or more StudioModel parameters, timers, focus-changes etc, Translators are implicitly triggered when the user originated event they are bound to occurs. In case of switches, the trigger value may be one of: Release. Single Press, Double Press, Hold.

An example of a working translator suitable for use with embodiments of the invention is reproduced in FIG. 5.

A Layout is a file that defines a number of related bindings for a specific set of user originated events. For example, this could be a layout to provide NUM-PAD functionality. A layout can he instantiated as a base layout, or can he pushed/popped on top of other layouts.

To efficiently map large numbers of functions to, for example, a physically small hardware control surface. embodiments of the invention support layering of layouts. In this way, layouts can push bindings on to the stack for a set of resources on a surface. Popping the layout removes those bindings. Each resource maintains its own stack of bindings, but “Base layouts” can also he loaded which clear the stacks of all resources included in the layout.

In particular, a hardware control surface may include at least one specific resource, a layout control element, which may take the form of for example, a switch. A layout control element may take the form of any user originated event, but is preferably a tactile control element. For example, when a user actuates a layout control element the layout of functions assigned to a pre-determined set of tactile control elements (resources) changes. A simple example would be a user actuating a ‘CALC’ key temporarily pushing a calculator layout onto a selection of keys (tactile control elements). Once the user is finished with the calculator functions, the ‘CALC’ key is actuated again, and will be “popped” off the keys, revealing what was there before. A collection of layouts may he application specific and/or controller specific.

In order to allow a user to push either a full or a partial layout on to the controller, by way of further example, where a key is labelled “Go To”, a user actuates that key, and in response as numeric keypad is displayed. This may be done with the following example translator script:

void PushLayout(const char*layout)

The opposite, that is. removal of a layout that a script previously pushed may he done with the following example translator script:

void PopLayout(const char*layout);

The following example translator script may allow a user to set a new base layout; that is, it removes any binding that might have been stacked up on the an various, for example, controls of a hardware control surface. A good example would be to set a QWERTY layout as the base layout; this is the starting point, and other layouts can then be stacked up on it on demand.

void SetBaseLayout(const char*layout);

Accordingly, the runtime technology may he constructed from the following components
Layout Engine—graphic user interface application that loads and manages layouts.
Tiny C—compiles the translators. (As noted above, “Tiny C” is just one example of scripting mechanism ‘C’, exemplified through a specific compiler “Tiny C”. This could equally well be, for example, a language such as Basic, executed via Microsoft's VBA).
Device connection—Network connection to control panels.
APIs—application specific interfaces, eg Actions and StudioModel interface functions in the case of DryIce.

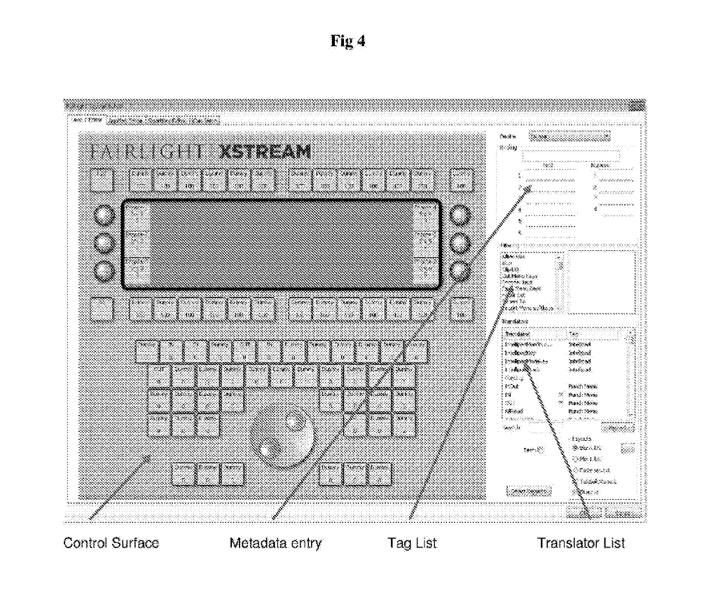

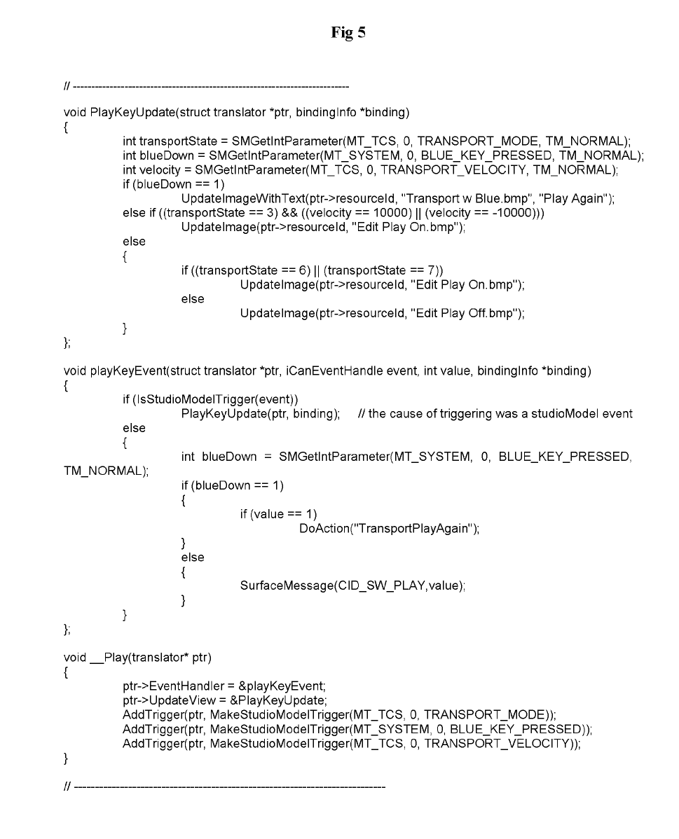

Referring to FIG. 4 there is reproduced a screenshot of a graphic user interface application configured to enable a user to arrange a pre-determined layout of functions assigned to one or more tactile control elements of an apparatus in accordance with embodiments of the invention. The graphic user interface application may allow drag-and-drop editing of a layout of functions assigned to one or more tactile control elements of the apparatus. En the example provided in FIG. 4, the user is presented with a graphical representation of the chosen hardware control surface along with a list of all available translators. New bindings may be created by dragging a translator onto a resource, moved/copied between resources, and the meta-data edited.

The graphic user interlace application may support embedded tags within the translator definitions, allowing sorting and filtering of the translator list. An example tag would he TRANSPORT, allowing the creation of a group of all transport-related translators.

There may be multiple tabs in the graphic user interface application:
Layout Manager; to manage the multiple layouts that typically makes up one User interface
Layout Editor: allows Drag-and-Drop editing of Layouts.
Translator Manager: allows editing of the tags and explain text associated with translators and macros.

The graphic user interface application may also support Macros. These are a family of translators using identical code where the graphic user interface application contains metadata for the translator to load and use. The metadata can he text (up to, for example, six (6) fields) or numeric (up to, for example, four (4) fields). An example of Macros could be ACTIONS. In this case the translator calls an action function whose text argument(s) are supplied from the metadata.

A Macro is a container that combines the following (with examples) into an entity that is available in a similar manner to a raw translator:
a display name (CR-MUTE)
a translator reference (SimpleStudioModelToggle)
text constants (“MUTE_ON.bmp”, “MUTE_OFF.bmp”)
numeric constants (MT_CR_MON. 0, MUTE)

Customization of layouts and translators may include different levels of customisation
User level: changes done on-site by either the user.
Custom level: custom feature sets maintained by the user interface provider.
Factory level: a base set of functionality for a user interface that may be installed unconditionally.

### Picture Key Technology

In preferred embodiments, the invention combines elements of the tactile user interface described in International Patent Publication No WO 2007134359, which is incorporated herein by reference, (referred to variously as Picture Keys and Picture Key Technology).

Picture Key Technology, in broad terms, involves the keys forming shells around the display mechanism, with a transparent window on the top to view the image. In this way, a display area may be viewable through a translucent cap for displaying a current function of the switch. An image conduit may be disposed between the display and the translucent cap. The image conduit may comprise a plurality of parallel optic fibres in fixed contact at a first end to the display area.

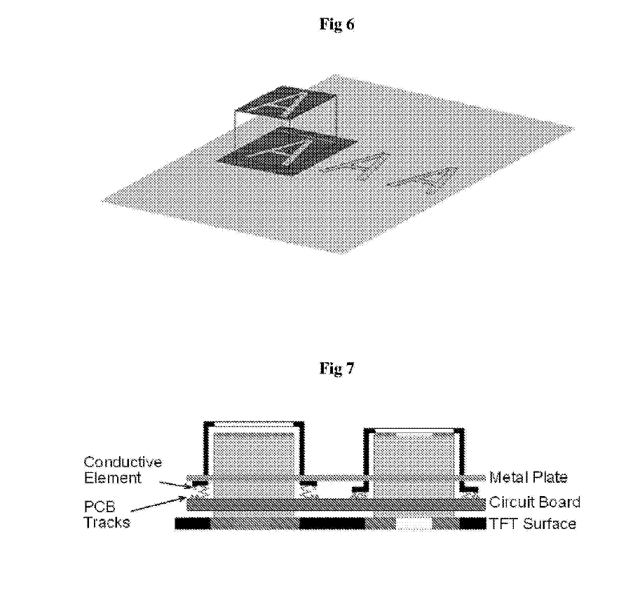

FIG. 6 is a schematic view of an image conduit comprising a plurality of parallel optic fibres in fixed contact at a first end to a display area. The optic fibres transmit an image from an underlying screen to the top of the block. As shown in FIG. 6. the letter A is brought up from the screen surface.

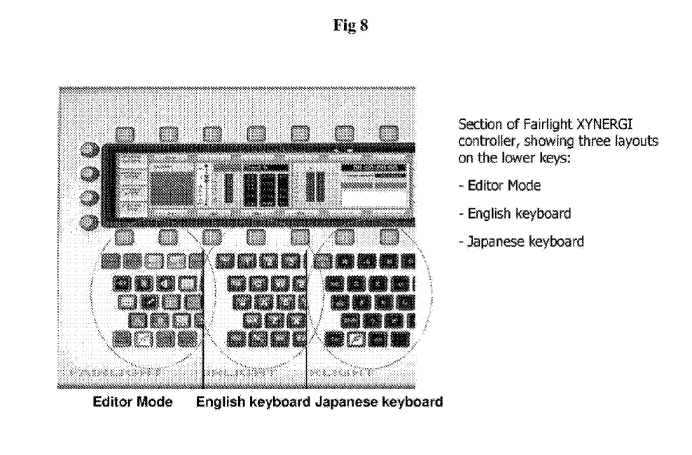

FIG. 7 depicts a simplified schematic of a switch mechanism comprising a translucent cap. The optic fibres arc mounted through openings in the Metal Plate (masking element) and the Printed Circuit Board (PCB), so they always rest in close contact with the Thin-Film Transistor (TFT) surface (display screen). The switch element may use a silicon keymat mechanism to push down its conductive elements and bridge tracks on the PCB. causing a switch event. Driving a simple TFT screen thus provides the basis for a rich and infinitely flexible tactile control element.

Keyboard layouts may therefore, for example, be changed inside an application. For example, foreign language versions arc simplified because the key graphics can he replaced with any required set. Referring to FIG. 8 there is depicted is a section view of a controller, showing three layouts on the lower Picture Keys in Editor Mode, English keyboard and Japanese keyboard. Nonetheless, in embodiments of the invention. Picture Keys may be combined with fixed keys and/or other tactile control elements.

The graphic user interface application may also allow users to insert their own labels for the tactile control elements, making use of, for example, in-house mnemonics and terms, assisting users with sight problems, helping with corporate branding, retaining legacy images from superseded products and giving personal involvement with one's tools of trade. Dynamic images may also be included in or adjacent tactile control elements by, for example, using an animated GIF as the image or adding a timer trigger to the translator, and programmatically sending image updates.

Critical functions may be placed near finger “feel-points” such as, for example corners, switch layout that creates more feel points, and the use of raised ridges for “home” keys, Embodiments of the invention therefore reduce the need to look at the hardware controller surface, and enhance the muscle-memory training that leads to unconscious operation and efficient use of applications.

Embodiments of the invention may also include an application that enables remote control. For example, a remote control application may:
Run On Windows 7 and/or Mac OS-X and/or any other operating system such as for example, Linux; and/or
Provide for basic Keyboard and Mouse interface functions; and/or
Have interface capabilities that are extensible via DLL; and/or
Auto-boot and Auto-configure.

Translators used in accordance with embodiments of the invention ma_{y} he tagged with various metadata to enhance the usability of the system. For example, including a unified way to display help text to the user wherein a translator may be annotated with help text that is displayed to the user in response to a “Explain xxx” to key sequence. All help text from all bound translators may be assembled into a searchable database. Special tags in the help text may identify data that enables the system to offer the user to “Find This Key”. To display the actual help text, the system may look up the help text in its dictionary, using the explain tag as the. key. Such a dictionary may be switched to a multitude of languages. For example, an on-line translation service, such as, for example, Google Translate, may be used to translate the help text to different languages.

In practice, a user interface might contain, for example, a feature to open a file. Therefore, a translator corresponding to that function may be called “OpenFile”. That translator may have explain tag with the value “explainOpenFile”. The dictionary contains the. English explain text for this key, being: “Press this key to open a file”. The dictionary also contains translations of this text, for example, “tryk paa denne knap for at aabne en fil” (in the Danish language).

The system may also support a teaching mechanism, The teaching syllabus may be split into topics. Topics in turn may he split into sub-topics, For example:

Topic: “How to do my filing”

Sub-Topic: “How to open a tile”

When a user accesses a teaching module, the user may be presented with a list of all Topics. The user may select a select a topic, and then he presented with a list of the relevant sub-topics. The user may select a sub-topic. and the system may then take the user through the desired operation step-by-step. For each step, the system may present an explanatory text. for example. “To open a file, press the OpenFile Key”, and the system at the same time flashes the control to activate. All topics and sub-topics may he managed through the dictionary, so they also can be switched to alternate languages.

As can he seen from the foregoing description of the preferred embodiments of the invention, it is plain that the invention may incorporate one or more of the following advantages:
A customisable user interface operable across a range of software applications.
A user may arrange the most commonly-used or logically grouped functions (for him or her) in a desired region.
Customisation of labels for particular functions.
Provision for a large number of functions combined with a user environment that reduces the “noise” of irrelevant choices.
Efficient use of physical space.

Although preferred forms of the invention have been described with particular reference to applications in relation to field of media production, it will be apparent to persons skilled in the art that modifications can he made to the preferred embodiments described above or that the invention can he embodied in other forms and used in alternative applications.

Throughout this specification and the claims which follow, unless the context requires otherwise, the word “comprise”, and variations such as “comprises” and “comprising”, will be understood to imply the inclusion of a stated integer or step or group of integers or steps. but not the exclusion of any other integer or step or group of integers or steps.

The reference in this specification to any prior publication (or information derived from it), or to any matter which is known is not, and should not be taken as an acknowledgment or admission or any form of suggestion that that prior publication (or information derived from it) or known matter forms part of the common general knowledge in the field of endeavour to which this specification relates.

1. An apparatus configured as a user interface for controlling software applications, the apparatus comprising;
a display screen;
an array of tactile control elements;
a masking element configured to conceal at least part of the display screen and reveal at least one display area, wherein at least one display area is for display in a current function of at least one tactile control element; and
a translator responsive to a user originated, event to carry out a function of one or more software applications assigned to the user originated event, wherein a user originated event includes the actuation of a tactile control, element to carry out the current function of the tactile control element, displayed on the display area,
wherein a graphic user interface application is configured to enable a user to assign functions of one or more software applications to user originated events and arrange a pre-determined layout of functions assigned to one or more tactile control elements of the apparatus.

2. An apparatus according to claim 1, further comprising:
at least one layout control element; and
a translator responsive to a user actuating a layout control element and configured to cause displaying of information, on at least one display area including displaying information corresponding to the current function of one or more tactile control elements,
wherein actuation of the layout control element changes between pre-determined layouts of functions assigned to one or more tactile control elements.

3. An apparatus according to claim 1, wherein at least one of the tactile control elements is a switch comprising a translucent cap and a display area viewable through the translucent cap for displaying a current function of the switch.

4. An apparatus according to claim 3, wherein an image conduit is disposed between the display and the translucent cap, the image conduit comprising a plurality of parallel optic fibers in fixed contact, at a first end to the display area.

5. An apparatus according to claim 1, wherein at least one of the tactile control elements is a knob configured to manipulate the information displayed on a display area.

6. An apparatus according to claim 2, wherein the layout control element is a tactile control element.

7. An apparatus according to claim 2, wherein the graphic user interface application is configured to allow drag-and-drop editing of a layout of functions assigned to one or more tactile control elements of the apparatus.

8. A user interface system for controlling software applications, the system comprising:
a graphic user interface application configured to enable a user to assign functions of one or more software applications to user originated events,
a translator responsive to a user originated event to carry out a function of one or more software applications assigned to the user originated event,
wherein the user originated events include one or more of: actuation of a tactile control element, a speech command, a two-dimensional gesture, a three-dimensional gesture.

9. A user interface system according to claim 8, the system further comprising:
a display screen;
at least one layout control element; and
a translator responsive to a user actuating a layout control element and configured to cause displaying of information on the display screen including displaying information corresponding to the current Function of one or more user originated events,
wherein actuation of the layout control element changes between pre-determined layouts of functions assigned to user originated events.

10. A user interface system according to claim 8, wherein the graphic user interface application is configured to allow drag-and-drop editing of the functions of one of more software applications assigned to user originated events.

11. A user interface system according to claim 9, wherein the graphic user interface application is configured to allow drag-and-drop editing of the functions of one of more software applications assigned to user originated events.

12. An apparatus according to claim 2, wherein at least one of the tactile control elements is a switch comprising a translucent cap and a display area viewable through the translucent cap for displaying a current function of the switch.

13. An apparatus according to claim 12, wherein an image conduit is disposed between the display and the translucent cap, the image conduit comprising a plurality of parallel optic fibers in fixed contact, at a first end to the display area.

15. An apparatus according to claim 2, wherein at least one of the tactile control elements is a knob configured to manipulate the information displayed on a display area.

16. An apparatus according to claim 3, wherein at least one of the tactile control elements is a knob configured to manipulate the information displayed on a display area.

17. An apparatus according to claim 4, wherein at least one of the tactile control elements is a knob configured to manipulate the information displayed on a display area.

18. An apparatus according to claim 3, wherein the layout control element is a tactile control element.

19. An apparatus according to claim 4, wherein the layout control element is a tactile control element.

20. An apparatus according to claim 5, wherein the layout control element is a tactile control element.
